(19) United States
(12) Patent Application Publication
(10) Pub. No.: US 2012/0139991 A1
(43) Pub. Date: Jun. 7, 2012

(54) PRINTER FOR DETERMINING PAPER TYPE USING REFLECTION

(76) Inventors: Thomas F. Powers, Webster, NY (US); Mark C. Rzadca, Fairport, NY (US); Thomas D. Pawlik, Rochester, NY (US)

(21) Appl. No.: 12/959,461

(22) Filed: Dec. 3, 2010

(51) Int. Cl. B41J 29/393

(52) U.S. Cl. 347/19

(57) ABSTRACT

A printer that determines paper type includes one or more short and long wavelength radiation sources sequentially outputting a short wavelength radiation and a long wavelength radiation onto a paper that reflects the long wavelength radiation and the short wavelength radiation is absorbed by a fluorescent compound in the paper resulting in the emission of long wavelength fluorescent radiation; a first detector that detects a long wavelength fluorescence signal resulting from the short wavelength source and a reflectance signal resulting from the long wavelength source; and a lookup table that determines a paper type from a plurality of paper types based on the fluorescence signal and reflectance signals.

### CROSS REFERENCE TO RELATED APPLICATIONS

Reference is made to commonly assigned U.S. patent application Ser. No. (Docket 96738) filed concurrently herewith by Thomas D. Pawlik et al., entitled “Inkjet Printers with Dual Paper Sensors”; commonly assigned U.S. patent application Ser. No. (Docket 96736) filed concurrently herewith by Thomas Foster Powers et al., entitled “Printer for Determining Paper Type Using Transmittance”; and commonly assigned U.S. patent application Ser. No. (Docket 96737) filed concurrently herewith by Thomas Foster Powers et al., entitled “Method for Determining Paper Type in Printers”, the disclosures of which are herein incorporated by reference.

### FIELD OF THE INVENTION

The present invention generally relates to inkjet printers having optical devices. In particular, the present invention relates to such optical devices that detect paper type using a sequence of short wavelength radiation in the range of 250 to 420 nm and long wavelength radiation in the range of 420 to 1000 nm that is used to determine paper type.

### BACKGROUND OF THE INVENTION

An inkjet printing system typically includes one or more printheads and their corresponding ink supplies. Each printhead includes an ink inlet that is connected to its ink supply and an array of drop ejectors, each ejector consisting of an ink pressurization chamber, an ejecting actuator and a nozzle through which droplets of ink are ejected. The ejecting actuator may be one of various types, including a heater that vaporizes some of the ink in the pressurization chamber in order to propel a droplet out of the orifice, or a piezoelectric device which changes the wall geometry of the chamber in order to generate a pressure wave that ejects a droplet. The droplets are typically directed toward paper or other recording medium in order to produce an image according to image data that is converted into electronic firing pulses for the drop ejectors as the recording medium is moved relative to the printhead.

A common type of printer architecture is the carriage printer, where the printhead nozzle array is somewhat smaller than the extent of the region of interest for printing on the recording medium and the printhead is mounted on a carriage. In a carriage printer, the recording medium is advanced a given distance along a media advance direction and then stopped. While the recording medium is stopped, the printhead carriage is moved in a direction that is substantially perpendicular to the media advance direction as the drops are ejected from the nozzles. After the carriage has printed a swath of the image while traversing the recording medium, the recording medium is advanced; the carriage direction of motion is reversed, and the image is formed swath by swath.

The ink supply on a carriage printer can be mounted on the carriage or off the carriage. For the case of ink supplies being mounted on the carriage, the ink tank can be permanently integrated with the printhead as a print cartridge, so that the printhead needs to be replaced when the ink is depleted, or the ink tank can be detachably mounted to the printhead so that only the ink tank itself needs to be replaced when the ink tank is depleted. Carriage mounted ink supplies typically contain only enough ink for up to about several hundred prints. This is because the total mass of the carriage needs be limited so that accelerations of the carriage at each end of the travel do not result in large forces that can shake the printer back and forth.

Pickup rollers are used to advance the paper from its holding tray along a transport path towards a print zone beneath the carriage printer where the ink is projected onto the paper. In the print zone, ink droplets are ejected onto the paper according to corresponding printing data.

It is noted that the inkjet printers use a plurality of different types of paper for printing. Some printers include a barcode reader adjacent to the pickup roller for reading a barcode on the non-print side of the paper as it passes beneath the barcode reader for detecting the type of paper. This permits the printer to adjust printing parameters according to the particular type of paper.

Although the currently used apparatuses and methods for detecting the paper type are sufficient, alternatives are always desirable to permit wider design selections based on design criteria. Consequently, the present invention provides apparatuses and methods for eliminating the need for barcodes and barcode readers.

### SUMMARY OF THE INVENTION

The present invention is directed to overcoming one or more of the problems set forth above. Briefly summarized, according to one aspect of the invention, the invention resides in a printer that determines paper type includes one or more short and long wavelength radiation sources sequentially outputting a short wavelength radiation and a long wavelength radiation onto a paper that reflects the long wavelength radiation and the short wavelength radiation is absorbed by the paper resulting in the emission of long wavelength fluorescent radiation; a first detector that detects a long wavelength fluorescence signal resulting from the short wavelength radiation source and a reflectance signal resulting from the long wavelength radiation source; and a lookup table that determines a paper type from a plurality of paper types based on the fluorescence signal and reflectance signals.

These and other objects, features, and advantages of the present invention will become apparent to those skilled in the art upon a reading of the following detailed description when taken in conjunction with the drawings wherein there is shown and described an illustrative embodiment of the invention.

### Advantageous Effect of the Invention

The present invention has the advantage of detecting paper type without the need for barcodes and barcode readers.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

While the specification concludes with claims particularly pointing out and distinctly claiming the subject matter of the present invention, it is believed that the invention will be better understood from the following description when taken in conjunction with the accompanying drawings, wherein:

FIG. 1 is a schematic representation of an inkjet printer system;

FIG. 2 is a perspective view of a portion of a printhead;

FIG. 3 is a perspective view of a portion of a carriage printer;

FIG. 4 is a schematic side view of a paper path in a carriage printer of the present invention;

FIG. 5 is a block diagram illustrating the components of both the non-print side reflected spectrum sensor and the print side reflected spectrum sensor;

FIG. 6 is also a block diagram illustrating a second embodiment of FIG. 5;

FIG. 7 is a third embodiment of FIG. 5;

FIG. 8 is fourth embodiment of FIG. 7;

FIG. 9 is a fifth embodiment of FIG. 8; and

FIG. 10 is a method of operating the physical embodiment of FIG. 7.

### DETAILED DESCRIPTION OF THE INVENTION

Before discussing the present invention, it is useful to have a clear understanding of the terms used herein. As used herein, a short wavelength is defined as being in the range of 250 to 420 nm and a long wavelength is defined as being in the range of 420 to 1000 nm. Also as used herein, the long wavelength radiation detector 103 is defined as being one physical integrated device or two or more separate devices that operate together. The preferred embodiment is one physical integrated device.

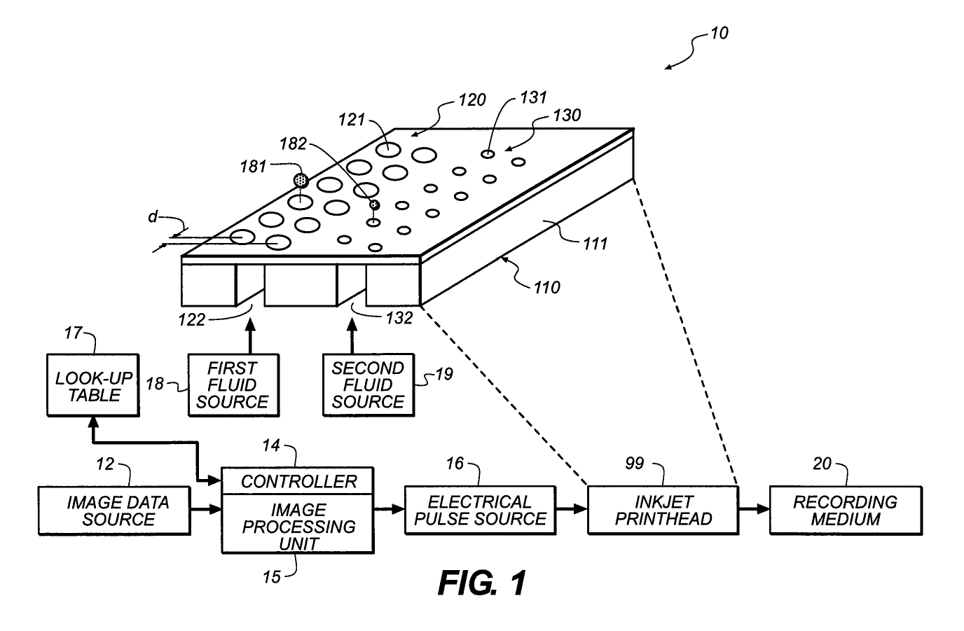

Referring to FIG. 1, a schematic representation of an inkjet printer system 10 is shown for its usefulness with the present invention and is fully described in U.S. Pat. No. 7,350,902, which is incorporated by reference herein in its entirety. Inkjet printer system 10 includes an image data source 12, which provides data signals that are interpreted by a controller 14 as being commands to eject drops. Controller 14 includes an image processing unit 15 for rendering images for printing, and the controller 14 outputs signals to an electrical pulse source 16 of electrical energy pulses that are inputted to an inkjet printhead 99, which includes at least one inkjet printhead die 110. A look-up 17 includes bi-directional communication with the controller 14 that is used in determining paper type as will be described in detail hereinbelow.

In the example shown in FIG. 1, there are two nozzle arrays. Nozzles 121 in the first nozzle array 120 have a larger opening area than nozzles 131 in the second nozzle array 130. In this example, each of the two nozzle arrays has two staggered rows of nozzles, each row having a nozzle density of 600 per inch. The effective nozzle density then in each array is 1200 per inch (i.e. d=1/1200 inch in FIG. 1). If pixels on the recording medium 20 were sequentially numbered along the paper advance direction, the nozzles from one row of an array would print the odd numbered pixels, and the nozzles from the other row of the array would print the even numbered pixels.

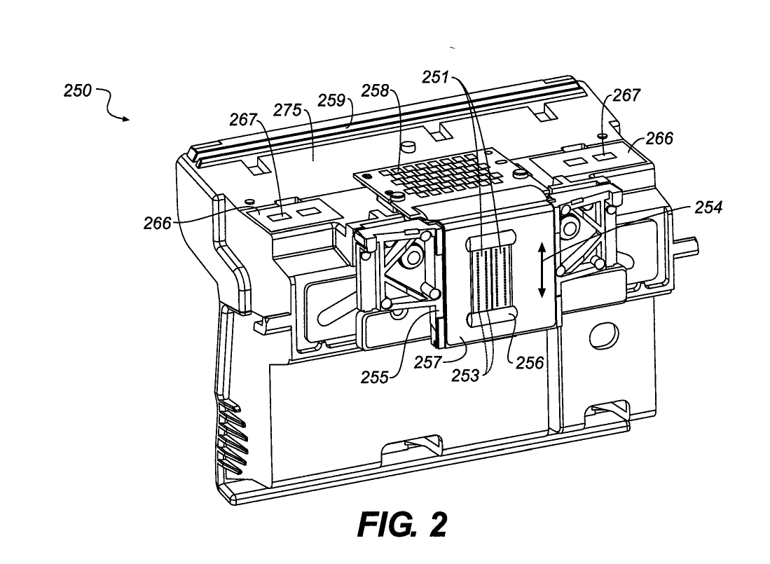

In fluid communication with each nozzle array is a corresponding ink delivery pathway. Ink delivery pathway 122 is in fluid communication with the first nozzle array 120, and ink delivery pathway 132 is in fluid communication with the second nozzle array 130. Portions of ink delivery pathways 122 and 132 are shown in FIG. 1 as openings through printhead die substrate 111. One or more inkjet printhead die 110 will be included in inkjet printhead 99, but for greater clarity only one inkjet printhead die 110 is shown in FIG. 1. The printhead die are arranged on a support member as discussed below relative to FIG. 2. In FIG. 1, first ink source 18 supplies ink to first nozzle array 120 via ink delivery pathway 122, and second ink source 19 supplies ink to second nozzle array 130 via ink delivery pathway 132. Although distinct ink sources 18 and 19 are shown, in some applications it may be beneficial to have a single ink source supplying ink to both the first nozzle array 120 and the second nozzle array 130 via ink delivery pathways 122 and 132 respectively. Also, in some embodiments, fewer than two or more than two nozzle arrays can be included on printhead die 110. In some embodiments, all nozzles on inkjet printhead die 110 can be the same size, rather than having multiple sized nozzles on inkjet printhead die 110.

The drop forming mechanisms associated with the nozzles are not shown in FIG. 1. Drop forming mechanisms can be of a variety of types, some of which include a heating element to vaporize a portion of ink and thereby cause ejection of a droplet, or a piezoelectric transducer to constrict the volume of a fluid chamber and thereby cause ejection, or an actuator which is made to move (for example, by heating a bi-layer element) and thereby cause ejection. In any case, electrical pulses from electrical pulse source 16 are sent to the various drop ejectors according to the desired deposition pattern. In the example of FIG. 1, droplets 181 ejected from the first nozzle array 120 are larger than droplets 182 ejected from the second nozzle array 130, due to the larger nozzle opening area. Typically other aspects of the drop forming mechanisms (not shown) associated respectively with nozzle arrays 120 and 130 are also sized differently in order to optimize the drop ejection process for the different sized drops. During operation, droplets of ink are deposited on a recording medium 20.

FIG. 2 shows a perspective view of a portion of a print cartridge 250, which is an example of an inkjet printhead 99 plus ink sources 18 and 19. Print cartridge 250 includes two printhead die 251 (similar to printhead die 110 in FIG. 1) that are affixed to mounting substrate 255. Each printhead die 251 contains two nozzle arrays 253 so that print cartridge 250 contains four nozzle arrays 253 altogether. The four nozzle arrays 253 in this example are each connected to ink sources (not shown in FIG. 2), such as cyan, magenta, yellow, and black. Each of the four nozzle arrays 253 is disposed along nozzle array direction 254, and the length of each nozzle array along the nozzle array direction 254 is typically on the order of 1 inch or less. Typical lengths of recording media are 6 inches for photographic prints (4 inches by 6 inches) or 11 inches for paper (8.5 by 11 inches). Thus, in order to print a full image, a number of swaths are successively printed while moving print cartridge 250 across the recording medium 20. Following the printing of a swath, the recording medium 20 is advanced along a media advance direction that is substantially parallel to nozzle array direction 254.

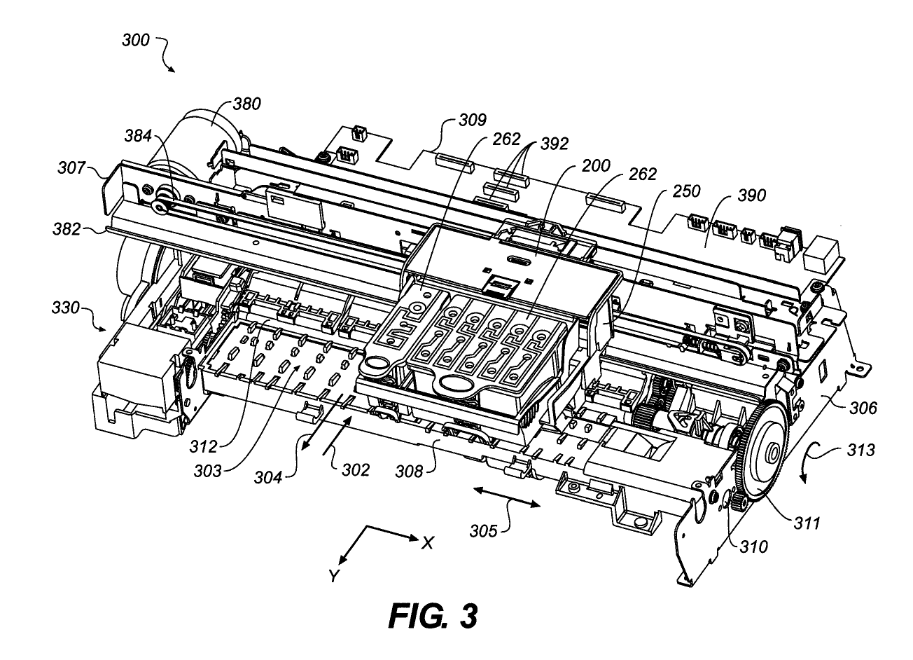

Also shown in FIG. 2 is a flex circuit 257 to which the printhead die 251 are electrically interconnected, for example, by wire bonding or TAB bonding. The interconnections are covered by an encapsulant 256 to protect them. Flex circuit 257 bends around the side of print cartridge 250 and connects to connector board 258 on rear wall 275. A lip 259 on rear wall 275 serves as a catch for latching print cartridge 250 into the carriage 200. When print cartridge 250 is mounted into the carriage 200 (see FIG. 3), connector board 258 is electrically connected to a connector on the carriage 200 so that electrical signals can be transmitted to the printhead die 251. Print cartridge 250 also includes two devices 266 mounted on rear wall 275. When print cartridge 250 is properly installed into the carriage of a carriage printer, electrical contacts 267 will make contact with an electrical connector on the carriage.

FIG. 3 shows a portion of a desktop carriage printer. Some of the parts of the printer have been hidden in the view shown in FIG. 3 so that other parts can be more clearly seen. Printer chassis 300 has a print region 303 across which carriage 200 is moved back and forth in carriage scan direction 305 between the right side 306 and the left side 307 of printer chassis 300, while drops are ejected from printhead die 251 (not shown in FIG. 3) on print cartridge 250 that is mounted on carriage 200. Carriage motor 380 moves belt 384 to move carriage 200 along carriage guide rail 382.

The mounting orientation of print cartridge 250 is rotated relative to the view in FIG. 2, so that the printhead die 251 are located at the bottom side of print cartridge 250, the droplets of ink being ejected downward onto the recording medium in print region 303 in the view of FIG. 3. Cyan, magenta, yellow and black ink sources 262 are integrated into print cartridge 250. Paper or other recording medium (sometimes generically referred to as paper or media herein) is loaded along paper load entry direction 302 toward the front of printer chassis 308.

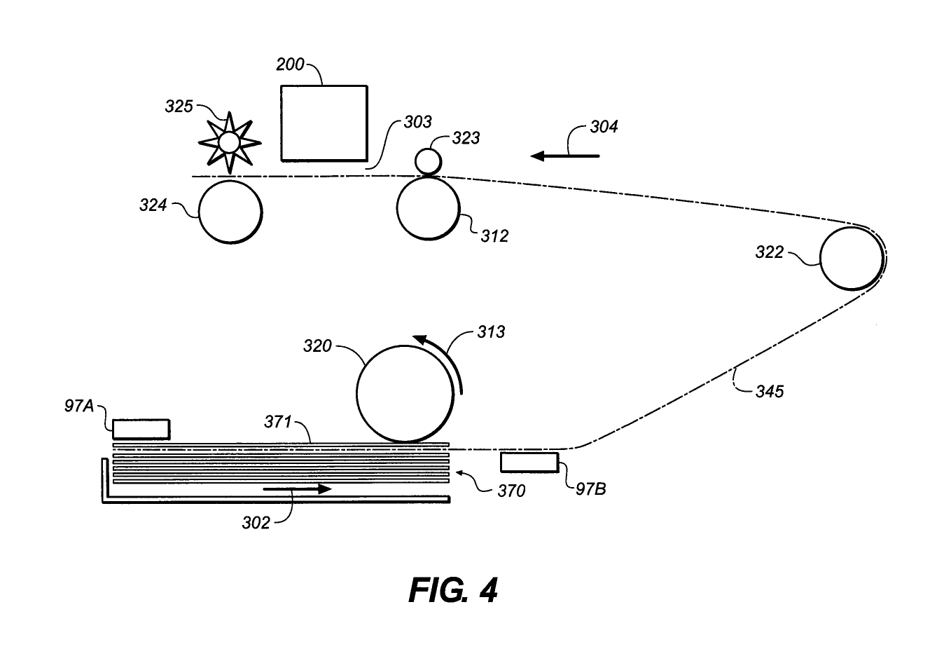

A variety of rollers are used to advance the medium through the paper transport path 345 (indicated by the dot dash lines) of the printer as shown schematically in the side view of FIG. 4. The paper transport path 345 is defined as the path the paper takes from its initial position in the paper stack 370 to its printing position in the print region 303. In this example, a pick-up roller 320 moves the top sheet of the paper 371 in the direction of arrow, paper load entry direction 302. A turn roller 322 acts to move the paper around a C-shaped path (in cooperation with a curved rear wall surface) so that the paper 371 continues to advance along media advance direction 304 from the rear 309 of the printer chassis (with reference also to FIG. 3). The paper 371 is then moved by feed roller 312 and idler roller(s) 323 to advance across print region 303, and from there to a discharge roller 324 and star wheel(s) 325 so that printed media exits along media advance direction 304. Feed roller 312 includes a feed roller shaft along its axis, and feed roller gear 311 (see FIG. 3) is mounted on the feed roller shaft. Feed roller 312 can include a separate roller mounted on the feed roller shaft, or can include a thin high friction coating on the feed roller shaft

The motor that powers the paper advance rollers is not shown in FIG. 3, but the hole 310 at the printer chassis right-side 306 is where the motor gear (not shown) protrudes through in order to engage feed roller gear 311, as well as the gear for the discharge roller (not shown). For normal paper pick-up and feeding, it is desired that all rollers rotate in forward rotation direction 313. Toward the printer chassis left-side 307, in the example of FIG. 3, is the maintenance station 330.

Toward the printer chassis rear 309, in this example, there is located the electronics board 390, which includes cable connectors 392 for communicating via cables (not shown) to the printhead carriage 200 and from there to the print cartridge 250. Also on the electronics board are typically mounted motor controllers for the carriage motor 380 and for the paper advance motor, a processor and/or other control electronics (shown schematically as controller 14 and image processing unit 15 in FIG. 1) for controlling the printing process, and an optional connector for a cable to a host computer.

Referring to FIG. 4, a non-print side reflected spectrum sensor 97A uses the non-print side (i.e, the side of the media opposite the side on which printing occurs) of the paper 371 to identify the particular type of paper currently being used for printing. For clarity of understanding, the printer uses any of a plurality of paper types for printing, and the printer of the present invention identifies the particular type of paper being used so that corresponding printing adjustments can be made. It is noted that the non-print reflected spectrum sensor 97A is positioned along the paper path 345 in a location suitable for detecting the non-print side. Although a preferred location is shown, the location may vary as long as the appropriate side is able to be detected. The details of the non-print side reflected spectrum sensor 97A will be described hereinbelow.

In another embodiment of the present invention, FIG. 4 also discloses a print side reflected spectrum sensor 97B that uses the print side (i.e., the side of the media on which printing occurs) of the paper 371 to identify the particular type of paper currently used for printing. The print side reflected spectrum 97B is placed anywhere along the paper path 345 suitable for detecting the print side. Although a preferred location is shown, the location may vary as long as the appropriate side is able to be detected. The details of the print side reflected spectrum sensor 97B will be described hereinbelow. In another embodiment of the invention, both non-print side reflected spectrum sensor 97A and print side reflected spectrum sensor 97B are positioned along the paper path. In this embodiment, the printer identifies the paper being printed by evaluating signals from both sensors 97A and 97B. In particular, a different response from sensors 97A and 97B is an indication for single-sided media, whereas a similar response from sensors 97A and 97B is an indication for double-sided media or plain paper. The sensors 97A and 97B can be positioned anywhere along the paper path 345 in a location suitable for detecting the non-print side or print side, respectively.

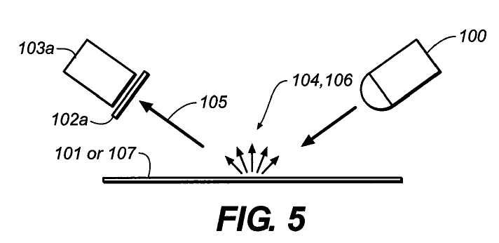

Referring to FIG. 5, there is shown the details of either the non-print side reflected spectrum sensor 97A or the print side reflected spectrum sensor 97B. It is noted, that in the case of the print side reflected spectrum sensor 97B, FIG. 5 inverts the orientation of the non-print side reflected spectrum sensor 97A since both the non-print side reflected spectrum sensor 97A and print side reflected spectrum sensor 97B have the same components and function, but differ only in physical orientation.

It is noted that a long wavelength and short wavelength radiation emitting source 100 sequentially emits both the long wavelength and short wavelength radiation onto the paper 371. As used herein, sequentially is defined as one after the other in any desired order, or in other words, the short wavelength source may be followed by the long wavelength source. The long wavelength and short wavelength radiation emitting source 100 may be either a single unit in which the long wavelength and short wavelength sources are contained within a single structure that sequentially emits long wavelength and short wavelength radiation, or two separate units in which one unit contains long wavelength radiation source and one unit contains short wavelength radiation source that respectively and alternately emits long wavelength and short wavelength radiation in a sequential manner. As used herein, long wavelength and short wavelength radiation source is defined as either the single unit or two separate units.

In the case of the non-print side reflected spectrum sensor 97A, the non-print side 107 of the paper (also referred to herein as non-print head side since it faces in a direction opposite the printhead during printing) is illuminated, and in the case of the print side reflected spectrum sensor 97B, the print side 101 (also referred to herein as printhead side since it faces the printhead during printing) is illuminated. The following drawings use 101 and 107 as indicating the same surface, but it is to be understood that only one type is being used depending on the particular application.

Turning now to the details of the present invention, the long wavelength radiation is reflected off the print side 101 or non-print side 107 as long wavelength radiation 104 and the short wavelength radiation is absorbed by a fluorescent compound in the paper resulting in the emission of long wavelength fluorescent radiation 106. A long wavelength radiation detector 103a is located on the same side of the paper as the long wavelength and short wavelength radiation emitting source 100 and detects the specular reflected radiation 105 of the reflected long wavelength radiation 104 and the emitted fluorescence radiation 106 when the paper is exposed to short wavelength radiation. A short wavelength radiation blocking filter 102 is positioned in the optical path of the long wavelength radiation detector 103 to eliminate any response to short wavelength radiation. These signals are sent to the controller 14 (see FIG. 1) which references a look-up table 17 for determining the type of paper based on the received fluorescence signal and reflectance signals. The controller 14 then directs printing adjustments, such as an amount of ink to apply and the color transforms to produce optimized color reproduction, through the image processing unit 15.

It is noted that the look-up table may in the form of electronic memory that stores a plurality of fluorescence and reflectance values that are used to determine the paper type. In other embodiments, the look-up table 17 may be software that runs a routine for determining the paper type. Although two embodiments are described, other suitable embodiments are also possible.

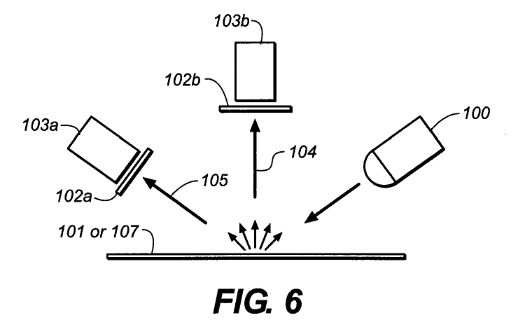

Referring to FIG. 6, there is shown another embodiment of the non-print side reflected spectrum sensor 97A or the print side reflected spectrum sensor 97B of FIG. 5. In this embodiment, there are all of the components described in FIG. 5 with an additional long wavelength detector 103b having a short wavelength blocking filter 102b both of which are located on the same side of the paper 371 as detector 103a and function similarly to the detector 103a and filter 102a. The detector 103b detects reflected diffused long wavelength and long wavelength fluorescence radiation that is emitted off the print side 101 or non-print side 107 when the paper is exposed to short wavelength radiation. The signals from detector 103a and 103b are then used by the controller 14 to determine the paper type as described hereinabove.

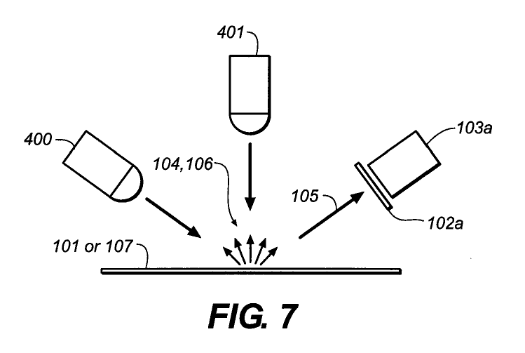

Referring to FIG. 7, there is shown an embodiment in which the short wavelength and long wavelength radiation emitting source 100, as shown in the previous embodiments, is separated into a short wavelength radiation emitting source 400 and long wavelength radiation emitting source 401 each located at significantly different angles in relation to the paper 371. When the radiation emitting source 401 emits long wavelength radiation, the detector 103a detects diffuse reflected radiation 104. When the radiation emitting source 400 emits short wavelength radiation, the short wavelength radiation is absorbed by a fluorescent compound in the paper 371 resulting in the emission of long wavelength fluorescent radiation 106 that is detected by detector 103a. These detected signals are then used as the previously described embodiments to detect the type of paper.

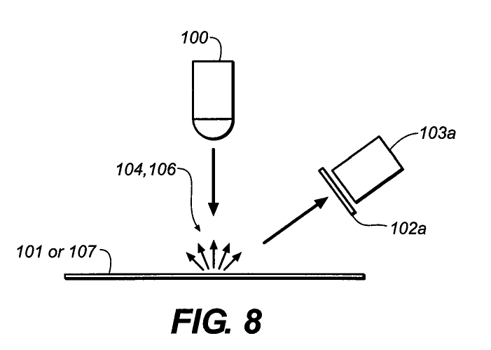

Referring to FIG. 8, there is shown the long wavelength and short wavelength radiation emitting source 100 positioned such that radiation strikes the paper 371 at a perpendicular angle or substantially perpendicular angle and diffuse reflectance long wavelength radiation 104 and fluorescent radiation 106 emitted by the paper when exposed to short wavelength radiation is detected by the detector 103a. The detector 103a also includes filer 102a.

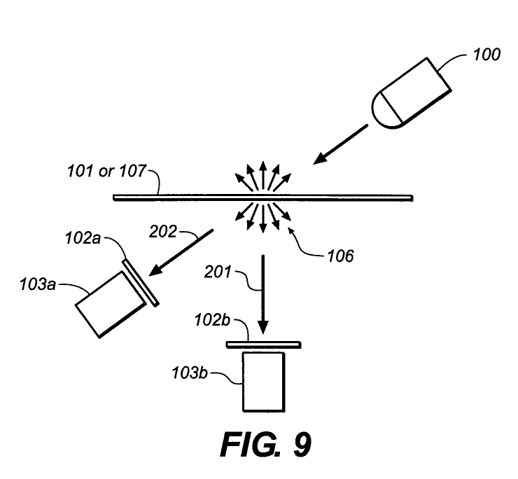

Referring to FIG. 9, the long wavelength and short wavelength radiation emitting source 100 and the detectors 103a and 103b are positioned on opposite sides of the paper 371. The long wavelength radiation is transmitted through the paper 371 and the short wavelength radiation is absorbed by a fluorescent compound in the paper 371 resulting in the emission of long wavelength fluorescent radiation 106 which is emitted from the paper 371. When the short and long wavelength radiation emitting source 100 emits long wavelength radiation, the detector 103a detects specular transmitted radiation 202 and the detector 103b detects diffuse transmitted radiation 201. When the short and long wavelength radiation emitting source 100 emits short wavelength radiation, both detectors 103a and 103b detect emitted fluorescence radiation 106. Each of the detectors respectively includes filters 102a and 102b. These signals are then used to determine the paper type which is then used for adjusting printing parameters.

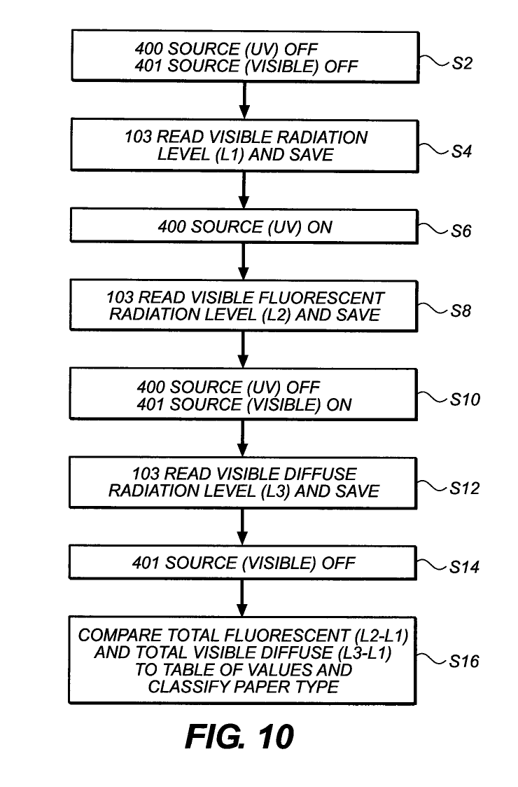

Referring to FIG. 10, there is a flowchart of the method of FIG. 7 of the present invention for determining the paper type. In this regard, initially both the long wavelength and short wavelength radiation sources are in the OFF state S2. The background long wavelength radiation, such as ambient light, is read and saved S4 so that light due to the environment may be taken into account as calibration when reading the long wavelength radiation due the short wavelength radiation emitting source 400 and long wavelength emitting source 401. The short wavelength source is turned to the ON state S6, and the resulting long wavelength fluorescence radiation is read and saved S8. The short wavelength radiation source is turned to the OFF state and the long wavelength radiation source is turned to the ON state S10. The long wavelength diffuse radiation is then read and saved S12 and eventually returned to the OFF state S14. The two signals are then used when referencing the look-up table to determine paper type S16.

Although FIG. 10 describes the present invention in reference to FIG. 7, those skilled in that art will readily recognize that the other embodiments are similar in operation and are an obvious derivation of FIG. 10.

The invention has been described in detail with particular reference to certain preferred embodiments thereof, but it will be understood that variations and modifications can be effected within the spirit and scope of the invention.

### PARTS LIST

10 Inkjet printer system

12 Image data source

14 Controller

15 Image processing unit

16 Electrical pulse source

17 Look-up table

18 First ink source

19 Second ink source

20 Recording medium

97A Non-print side reflected spectrum sensor

97B Print side reflected spectrum sensor

99 Inkjet printhead

100 Emitting source

101 Paper, print side

102a and 102b Short wavelength radiation blocking filter

103a and 103b Long wavelength radiation detector

104 Diffuse reflected radiation

105 Specular reflected radiation

106 Long wavelength fluorescence radiation

107 Paper, non-print side

110 Inkjet printhead die

111 Substrate

120 First nozzle array

121 Nozzle(s)

122 Ink delivery pathway (for first nozzle array)

130 Second nozzle array

131 Nozzle(s)

132 Ink delivery pathway (for second nozzle array)

181 Droplet(s) (ejected from first nozzle array)

182 Droplet(s) (ejected from second nozzle array)

200 Carriage

201 Diffuse transmitted radiation

202 Specular transmitted radiation

250 Print cartridge

251 Printhead die

253 Nozzle array

254 Nozzle array direction

255 Mounting substrate

256 Encapsulant

257 Flex circuit

258 Connector board

259 Lip

262 Ink sources

266 Device

267 Electrical contact

275 Rear Wall

300 Printer chassis

302 Paper load entry direction

303 Print region

304 Media advance direction

305 Carriage scan direction

306 Right side of printer chassis

307 Left side of printer chassis

308 Front of printer chassis

309 Rear of printer chassis

310 Hole (for paper advance motor drive gear)

311 Feed roller gear

312 Feed roller

313 Forward rotation direction (of feed roller)

320 Pick-up roller

322 Turn roller

323 Idler roller

324 Discharge roller

325 Star wheel(s)

330 Maintenance station

345 Paper transport path

370 Stack of paper

371 Paper

372 Barcode

373 Barcode lines

374 Non-print side of media

380 Carriage motor

382 Carriage guide rail

384 Belt

390 Printer electronics board

392 Cable connectors

400 Short wavelength radiation emitting source

401 Long wavelength emitting source

1. A printer that determines paper type comprising:
(a) a short and long wavelength radiation source sequentially outputting a short wavelength radiation and a long wavelength radiation onto a paper that reflects the long wavelength radiation and the short wavelength radiation is absorbed by the paper resulting in the emission of long wavelength fluorescent radiation;
(b) a first detector that detects a long wavelength fluorescence signal resulting from the short wavelength source and a reflectance signal resulting from the long wavelength source; and
(c) a lookup table that determines a paper type from a plurality of paper types based on the fluorescence signal and reflectance signals.

2. The printer as in claim 1, wherein the first detector is positioned on a same side of the paper as the short and long wavelength radiation source and detects emitted fluorescence and reflectance signals.

3. The printer as in claim 2, wherein the first detector detects specular reflectance signals and emitted fluorescence signals.

4. The printer as in claim 3, further comprising a second detector positioned on the same side of the paper as the short and long wavelength radiation source, which second detector detects emitted fluorescence signals and diffuse reflectance signals.

5. The printer as in claim 1, further comprising a controller that adjusts printing parameters based on the paper type.
